(19) United States
(12) Patent Application Publication
(10) Pub. No.: US 2016/0333636 A1
(43) Pub. Date: Nov. 17, 2016

(54) ACTIVE BUILDING WINDOW

(71) Applicant: SAES GETTERS S.P.A., Lainate, MI (IT)

(72) Inventor: Antonio BONUCCI, HAMBURG (DE)

(21) Appl. No.: 15/112,161

(22) PCT Filed: Jan. 21, 2015
(86) PCT No.: PCT/IB2015/050463

§ 371 Date: Jul. 15, 2016

(30) Foreign Application Priority Data
Feb. 20, 2014 (IT) MI2014A000245

(51) Int. Cl. E06B 9/264; E06B 9/386; E06B 3/66

(52) U.S. Cl. CPC E06B 9/264; E06B 3/66; E06B 3/6612; E06B 9/386; E06B 2009/2643; E06B 2009/2464

(57) ABSTRACT

An active window containing a Venetian blind made by N slats parallel to each other, wherein the slats comprise an electrochromic active material capable of varying their light throughput by controlling the transmittance and/or reflectance of the slats is described. The width of the slats being between 10% and 95% of a defined distance between two glass panes. The slats may be made of the electrochromic active material or the electrochromic active material may be layered onto the upper layer of the slats.

The present invention refers to solutions for improving the illumination quality of living and working habitats, with reference to the control of the incoming environmental light by means of active building windows.

As everyone knows and experiences, during the day there is usually a wide variation in the incoming light from the environment, variation linked to season, time, weather conditions. Associated with these variations there is the need to alter/control external light access to habitats in order to maintain a comfortable level and type of illumination, both to avoid glaring effects as well as to avoid energetic waste linked to an excessive use of artificial lighting.

One of the best known and most widely employed solutions for controlling the amount of environmental light in habitats is by means of Venetian blinds adjacent/coupled to building windows. This solution offers the following advantages:
blocks direct incoming solar radiation,
if properly oriented, avoids glaring by preventing direct projection of the solar disk in occupied portions of the habitat,
redirects light towards the ceiling or other parts of the habitat, so that it provides a contribution to the habitat lighting,
allows for incoming incident light in case of cloudy skies or when there is no direct projection of the solar disk.

One of the major drawbacks of this solution is associated with the fixed constitutional features of the blinds, i.e. their inability to vary and control properties such as transmittance, reflectance and color.

On the contrary, in the shading technical field there are known windows made with electrochromic materials, sometimes referred in the field with the acronym ECW (ElectroChromic Windows), that are windows realized or comprising (for example, coated with) materials that alter their light transmission properties (color, transmittance, reflectance) when supplied with an electric current. More information on these devices and their control can be found in the US patent application 2013/264,948.

Major advantages of the ECW are:
maximization of the incoming light with respect to a pre-set goal,
glaring reduction through the lowering of the light transmittance,
maximization of the incoming light by taking the light transmittance to the maximum.

The major drawbacks of ECW-based solutions are that they reduce only partially the glaring effect, in particular in case of non-uniform incident light the adjustment of the ECW only mitigates the discomfort, and additionally the regulations made are at the expense of the incoming light. Venetian blinds control glaring and through reflection render available part of the incident light, but at the expense of the outside visibility. Generally speaking ECW are more efficient in reducing the cooling energetic consumption of buildings in summertime, while Venetian blinds are energetically more efficient in glare reduction. This is evidenced for example in tables 4 and 6 of the article “Comparative energy and economic performance analysis of an electrochromic window and automated external venetian blind” published on Energy Procedia 30 (2012), pages 404-413. As reported in this paper, by using an automatic vertical blind the energy consumption for shading is lower with respect to the electrochromic windows and the glare index was limited below the critical value of discomfort.

The object of the present invention is to provide a solution for controlling the incoming environmental light capable of exploiting in a synergetic way the features and positive aspects of Venetian blinds and ECW, and in a first aspect thereof consists in an active window comprising two glass panes spaced by a distance d, each of said glass panes having an area A comprised between 0.09 and 2 m², and a frame for the hermetic sealing of the active window, wherein within said window is disposed a Venetian blind made by N slats parallel to each other, the width of said slats being comprised between 10% and 95% of said distance d, characterized in that said slats comprise an electrochromic active material capable of varying their light throughput.

The variation of light throughput is achieved by controlling the transmittance and/or reflectance of the slats that will alter and affect the amount of light admitted into the habitat as well as the incoming light illumination mechanism, from totally or partially direct to partially scattered light, or a combination of the two for slats that are both semi-transparent and semi-reflective.

The slats comprise a variable transmission material and in particular the bulk of the slats itself may be made with the variable transmission (and/or reflectance) material, or the active material could be coated on at least the upper surface of the slats. In the following reference will be made to variable transmission materials, but the same considerations can be made with reference to active materials with variable and controllable reflectivity as well as hybrid solutions with the simultaneous control of transmission and reflectivity.

Variable light transmission systems most suitable to carry out the present invention are electrochromic or photovoltachromic ones. It is pointed out that the purpose and aim of the present invention is not on novel variable transmission materials or systems, but on a novel way to use and integrate these materials to obtain an active building window with enhanced properties and performances.

A photovoltachromic system can be obtained by vertical integration (coupling) of an electrochromic system with a photovoltaic system, intended in its more general meaning of a power generating device from solar radiation, therefore also systems such as solar cells are encompassed, one of the most interesting systems in this latter category being DSSC (dye sensitized solar cells).

Other integrated systems that can be considered such are the ones described in the article “Highly efficient smart photovoltachromic devices with tailored electrolyte composition” published on Energy & Environmental Science, 2011, number 4 pages 2567-2574.

An electrochromic system usually comprises the elements listed below:
a first and second transparent or partially transparent substrate, usually made with the same material, preferably made of glass or polymer, PET; these can be also partially transparent and with a relevant scattered portion of transmitted light;
a first and second transparent electrode (most commonly made with ITO);
a first electrochromic layer (i.e. the active material);
an electrolyte as for instance a polymer adhesive (PEO, polyethylene oxide), in which is dissolved a salt MX (NaCl, LiClO₄) or poly-2-acrylamido-2-methyl-propane (PAMPS) which provides its own H⁺ ion;
a second electrochromic layer (i.e. the active material), wherein the second electrochromic layer can be substituted by a non-coloring redox material.

Examples of suitable active materials, for these systems are:
electrochromic oxides chosen from WO₃, Nb₂O₅, NiO, MoO₃, Ir₂O₃, mixed oxides such as antimony-tin oxide (ATO), polyoxometallates, viologens, Prussian blue, phthalocyanines typical of so-called all-solid electrochromic systems,
electroactive polymers (all conducting polymers), such as Polypyrroles (PPys), polyanilines, polythiophenes, C60 in thin-film form, alkali-substituted polythiophene, PEDOT (poly(3,4-ethylenedioxythiophene), PEDOP (poly(3,4-ethylenedioxypyrrole),
viologens and tetramethyl-p-phenylene-diamine (TMPD) that are typical of the so called all-liquid electrochromic systems and where the electrochromic agent is dispersed in the electrolyte,
cyanophenylparaquat species, typical of so-called solid-liquid electrolyte,
electrically-driven systems like liquid crystalline and suspended particle displays, in this case electrolytes and second electrochromic layers are optional
switchable mirrors based on:
   a. hydrogen-induced phase transitions (switching may be achieved electrochemically or by exposure to hydrogen and oxygen gases) of:
      1. rare earths and mixtures of rare earths,
      2. transition metals with magnesium, for instance Mg₄Ni/Pd/Al/Ta₂O₅/HₓWO₃/indium-tin oxide (ITO)
   b. copper/copper oxide, by anodic formation of copper oxide films on bulk copper electrodes in alkaline electrolytes, for example by electrochemical cycling, that can be carried out in a 0.1 M NaOH solution using a Pt counter-electrode and HgO/Hg reference electrode.
   c. interconversion of metallic and semiconducting phases via lithiation and delithiation in a non-aqueous electrolyte (preferred ones are antimony or bismuth); electrochemical cycling can be carried out with 1 M LiClO₄ in propylene carbonate, using lithium foil counter- and reference electrodes.

A coupled photovoltachromic stack is made by a solar cell stack and an electrochromic stack, vertically layered and electrically connected.

An integrated photovoltachromic encapsulated stack is made with a transparent substrate, a transparent cathode, an electronic semiconductor, a dye, an electrolyte, an electrochromic layer (the active material) and a counter-electrode and again a transparent or partially transparent electrode on a transparent or partially transparent substrate. As before, the cathode and substrate can be partially transparent and with a relevant portion of scattered light in the transmission or reflectance.

For the present invention the use of the following materials and configurations are provided.

For substrate and encapsulation: glass (2.2 mm) or a flexible and thin solution based on polyimide functionalized with layers of SiO₂ or titanium nitride (50-100 micron).

For the transparent cathode: fluorine-doped tin oxide (SnO₂:F) usually just deposited on the glass or on the plastic substrate (PET). Other suitable alternatives could be In₂O₃, SnO₂, ZnO and their combinations as well as ITO.

For the electronic semiconductor: a mesoporous oxide layer composed of nanometer-sized particles which have been sintered together to allow electronic conduction, most suitably TiO₂ nanostructured layers. Normally they are used in the form of paints, dispensable for screen printing on the glass and then subjected to calcination to obtain a layer of about 4-10 microns of thickness with particles between 10 and 30 nm. Scatterers may be added to increase/add a diffusion effect, at the expense of the overall transparency. Also wide band gap oxides can be used such as ZnO, Nb₂O₅ already investigated in literature, and Fe₂O₃, WO₃, Ta₂O₅, CdS, CdSe. The adding of nanoparticles can increase scattering for both the reflected and the transmitted light. More details in this regard can be found in the international patent application WO 2011/076492 in the applicant's name.

Preferably the same dyes normally used for DSSC are employed: Z-709, N₃, N719, “black dye” tri (cyanato)-2, 2′2″-terpyridyl-4, 4′4″-tricarboxylate Ru (II). The use of dyes of complementary colors in the electrochromic layer may be envisioned in order to harmonize the spectrum of light. For example a Prussian blue electrochromic dye (iron (III) hexacyanoferrate (II)) can be associated with a dye with an absorption spectrum that absorbs in the blue (N₃).

For the electrolyte: LiI solutions are particularly advantageous, for example a liquid electrolyte solution and 0.1 M LiI 0:01 butylpyridinein M4-t-g-butyrolactone. It is also possible to disperse agents directly in the electrolyte as in the case of the all-liquids electrodes (viologens or TMPD tetramethyl-p-phenylene-diamine).

For the electrochromic layer: the preferred material is WO₃, even though all the previously described materials for the electrochromic/photovoltachromic device may be suitably used. This layer can be also patterned with the counter-electrode to have a tailored distribution of the shading effect.

For the counter-electrode: Pd and Pt layers are preferably used.

The encapsulated photovoltachromic slats can have a thickness determined by the encapsulation (the stack can be in the order of microns), so that, with polyimide or polyamide, it can be comprised between 50-100 μm, therefore well below the thickness of a standard Venetian blind slat. In the case of the use of glass, the transparency of the material can give a limited effect of optical discontinuity. In both cases, this allows to realize active windows with thinner slats or limited optical discontinuity, with a consequent better transparency, or to attach the encapsulated photovoltachromic stack to a standard Venetian blind.

The use of photovoltachromic blinds is preferred to electrochromic blinds not only for the possibility to create an auto-consistent module, i.e. a module capable to generate itself the energy required to tilt the slats, but also for a different technical effect. In particular photovoltachromic slats will automatically respond to incident light, varying their transmission properties, so in case of non-uniform incident light there will be also a differential shading due to transparency variation, whereas an electrochromic material will alter its properties starting from the periphery (electrodes).

This property of photovoltachromic slats provides a further improvement in a situation of non-uniform external illumination, for example external non-uniform shadowing during sunset or sunrise.

Notwithstanding the materials used in or on the slats for the active building window according to the present invention, the blind structure usefully possesses some geometrical characteristics and other constitutional features. In this regard the distance, intended as vertical or horizontal distance between two adjacent slats, is constant in each window and comprised between 4 and 100 mm. Moreover the slats are preferably tiltable or their tilting angle can be adjusted; with regard to this aspect it is preferred to use shape memory elements/solutions in order to vary this angle, as for example described in U.S. Pat. No. 5816306. Generally speaking, there are two main ways to achieve tilting: by means of spring or wires; in the latter case particularly preferred is the use of opposed couple of wires.

The preferred shape memory material to be used in the active building window according to the present invention is nitinol, see for example U.S. Pat. No. 8430981 for some additional details on the latest developments and improvements on this alloy.

The active building windows according to the present invention are designed as plug-in modules (if the slats comprise electrochromic materials) or self-sustaining modules (if the slats comprise photovoltachromic materials). In both cases the windows are hermetic to avoid degrading of the performances of the window due to atmospheric agents, for example moisture condensation, and also to prevent degradation phenomena for the active materials. Especially for the latter reason, the windows are preferably filled with a gas chosen from dry air, nitrogen, argon, krypton at a pressure comprised between 900 and 1100 bar, or alternatively evacuated at a pressure below 10⁻³ mbar.

What is claimed is:

1. An active window comprising:
two glass panes spaced by a distance d, each of said glass panes having an area A comprised between 0.09 and 2 m²; and
a frame for the hermetic sealing of the active window,
wherein within said window is disposed a Venetian blind made by N slats parallel to each other, the width of said slats being comprised between 10% and 95% of said distance d,
wherein said slats comprise an electrochromic active material capable of varying their light throughput by controlling the transmittance and/or reflectance of the slats.

2. The active window according to claim 1, wherein the slats are made with the active material.

3. The active window according to claim 1, wherein the active material is layered onto the upper surface of the slats.

4. The active window according to claim 1, wherein the distance between adjacent slats is constant and comprised between 4 and 100 mm.

5. The active window according to claim 1, wherein said slats are tiltable.

6. The active window according to claim 5, wherein said tilting is achieved through a shape memory alloy material in the form of springs or wires, said shape memory alloy material being preferably nitinol.

7. The active window according to claim 1, wherein the window is filled with a gas chosen from dry air, nitrogen, argon, krypton at a pressure comprised between 900 and 1100 mbar.

8. The active window according to claim 1, wherein the window is evacuated at a pressure below 10⁻³ mbar.

9. The active window according to claim 1, wherein the active material is embedded into a system connected to a photovoltaic element.

10. The active window according to claim 1, wherein the active material is integrated within a photovoltaic element.
